(19) United States
(12) Patent Application Publication
(10) Pub. No.: US 2010/0231926 A1
(43) Pub. Date: Sep. 16, 2010

(54) APPARATUS FOR DETERMINING THE POSITION OF AN INDUSTRIAL TRUCK

(75) Inventors: Frank Mänken, Henstedt-Ulzburg (DE); Eckhard Schulz, Henstedt-Ulzburg (DE); Martin von Werder, Ammersbek (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: JUNGHEINRICH AKTIENGESELLSCHAFT, Hamburg (DE)

(21) Appl. No.: 12/721,970

(22) Filed: Mar. 11, 2010

(30) Foreign Application Priority Data
Mar. 13, 2009 (DE) 10 2009 013 671.1

(51) Int. Cl. G01B 11/14

(52) U.S. Cl. 356/614

(57) ABSTRACT

An apparatus for determining the position of an industrial truck within a spatial area, in which plural light sources are positioned at predefined locations and emit a radiation that unambiguously characterises the light source without interaction with the industrial truck, wherein the industrial truck has a receiving unit for the radiation of the light sources, which is adapted to identify the light source from the received radiation and to determine an angle of the light source with respect to a vehicle-stationary axis, and the industrial truck further has an analysing unit which is adapted to determine the position of the industrial truck from at least three identified light sources and the angles thereof.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to an apparatus for determining the position of an industrial truck within a spatial area.

Different systems are known for determining the position of industrial trucks in a spatial environment. One system is marketed under the name Sky-Trax as an indoor vehicle positioning system. In this system, two-dimensional bar codes are attached on the ceiling of a warehouse. The bar codes carry an unambiguous identification key, for which the position of the bar code in the warehouse is registered. A bar code reader is attached on the roof of the industrial truck and can read the bar codes that are attached on the ceiling. The actual position of the vehicle within the warehouse is then determined for the read-out bar code via a computer existing on board of the vehicle.

It is also known to provide RFID transponders in the floor of a warehouse and to equip the industrial truck with a RFID reading device. The industrial truck can then determine an actual position from the respective RFID transponders that were recognised in the floor.

From EP 0 639 902 B1, the entire contents of which is incorporated herein by reference, a method for determining the position of a moving vehicle in a limited space and an apparatus for the execution of the method is known. A rotating light source is provided on a vehicle in the known method. The light beam emitted by the light source hits active reflectors which diffusely emit a signal with an unambiguous code, being activated by the arriving light beam. The active reflector is unambiguously characterised by the code. The reflector signal is received by the vehicle and analysed to determine the vehicle's position.

The present invention is based on the objective to provide an apparatus that permits a reliable determination of the industrial truck's position with means that are as simple as possible.

### BRIEF SUMMARY OF THE INVENTION

The apparatus of the present invention serves for determining the position of an industrial truck within a spatial area in which plural light sources (18, 20, 22, 24) are positioned at predefined locations. The spatial area may be a warehouse as well as an open space. The light sources are adapted to emit a radiation that unambiguously identifies the light source without interaction with the industrial truck. The radiation identifying the light source can be received in an angular range by one or plural industrial trucks, wherein the light source may be disposed in an arbitrary height in the room. The light sources emit their radiation without that any influence of the industrial truck to the light source has been made for this. As the radiation, it is preferably dealt with electromagnetic radiations, which may be emitted in the visible region, but also in the invisible frequency spectrum. The industrial truck is equipped with a receiving unit for the radiation of the light sources. The receiving unit is adapted to identify the light source from the received radiation and to determine an angle of the light source with respect to a vehicle-stationary axis. The vehicle-stationary axis may be set arbitrarily on the vehicle in this. The receiving unit determines the angle under which the received radiation hits the vehicle or the receiving unit, respectively, with respect to this vehicle-stationary axis. The industrial truck is furthermore equipped with an analysing unit, which is adapted to determine the position of the industrial truck from at least three identified light sources and the angles thereof with respect to the vehicle-stationary axis. The analysing unit can unambiguously determine the position of the industrial truck from the position of three light sources. Because the light sources are situated in defined positions, the position of the light sources is known to the analysing unit. The position of the industrial truck can be accurately determined from the angles under which the radiation of the light sources is received and from the position of the light sources. The apparatus of the present invention has the particular advantage that it may be flexibly used in different environments. It is not dependent on a specially formed floor neither on particular means on the ceiling or in a warehouse. A technically sumptuous measurement of the runtime of the radiation is also not necessary. A particular advantage of the present invention is also that plural vehicles can receive and analyse the radiation at the same time.

In a preferred embodiment of the apparatus of the present invention, each of the light sources emits the radiation that identifies the light source permanently or according to a predetermined time plan.

In a preferred embodiment of the apparatus of the present invention, each light source has an unambiguous identification key which is modulated onto the emitted radiation. By the demodulation of the received radiation, the identification key may be extracted from the signal and the light source may be identified through this. The absolute position of the light source is decisively determined via the identified light source itself.

The identification key is preferably modulated onto the radiation by a radiation with two different intensities. By different intensities is also to be understood that a light source is switched on and off, the second intensity then being related to the cut-out light source. Besides to the intensity, other physical properties of the light source can in principle be used also in order to modulate the identification key. A polarisation or the frequency of the radiation could be mentioned in this context.

In an also preferred embodiment, the light sources emit their radiation each with a predetermined frequency and/or in a predetermined frequency interval. In this, the information concerning the light source may also be contained in the selected frequency and/or in the selected frequency interval, without that an identification key had been modulated onto the emitted radiation.

In a preferred embodiment, the receiving unit is disposed on a height-adjustable component of the industrial truck, and the analysing unit is adapted to determine the position of the industrial truck and the height of the component from at least four identified light sources and their angles. Whereas it is sufficient to identify three light sources in order to determine the position of the industrial truck, for the additional information regarding the height it is only necessary to identify one further light source.

Different embodiments are possible for the receiving unit. In one possible embodiment of the receiving unit, a plurality of circularly disposed photodiodes is provided, which can receive the radiation in a predetermined angle interval. The receiving unit can determine the direction of the light source in that one of the photodiodes in the annular arrangement responds to the radiation. Because the receiving unit is fixedly mounted on the vehicle, the information under which angle the light source has been received with respect to a vehicle-stationary axis is therefore obtained also.

In an alternative embodiment, the receiving unit has one or plural photodiodes which are disposed on a rotatable holder. The photodiodes can receive the radiation of one of the light sources in a predetermined angle interval and the holder is adapted to be traversed into a defined angular position with respect to the vehicle-stationary axis. In this embodiment, the photodiode detects whether a radiation had been received and it records the received radiation for demodulation. The angle under which the radiation had been received is determined from the angular position of the rotatable holder having the photodiode.

In a further possible embodiment, the receiving unit has at least one deflecting body via which the radiation of the light source is received by plural photodiodes. The incident radiation is deflected depending on the angle of incidence of the radiation via the deflecting body, and directed to at least one photodiode. The deflecting body may be a rotatable mirror arrangement e.g., whose angular position is detected when the radiation hits the photodiode. The angle of the incident radiation is then known from the angle of the mirror arrangement. Alternatively, it is also possible to provide a transparent body as the deflecting body, for instance a prism or a tetrahedron. A refraction of the incident radiation occurs on this deflecting body, the angle of emersion of the refracted radiation from out the deflecting body being dependent on the angle of incidence of the radiation. The angle of the deflected radiation can then be determined via the plural photodiodes behind the deflecting body, and from this, the angle of incidence of the radiation onto the deflecting body can be counted back.

In a further, preferred embodiment, the receiving unit has at least one two-dimensional photo sensor, wherein the analysing unit and/or the photo sensor determine(s) the angle of the light source with respect to the vehicle-stationary axis from the position of the incident radiation on the two-dimensional photo sensor. The two-dimensional photo sensor may be a CCD photo array for instance, which captures a predetermined angular region with or without optics. When the radiation occurs within this angular region, the angle with respect to the vehicle-stationary axis can be determined from the position of the radiation arriving on the two-dimensional photo sensor.

The method of the present invention serves for determining the position of an industrial truck within a spatial area in which plural light sources emit a radiation unambiguously characterising the light source from out predefined positions. The emission of the radiation occurs without activation or other interaction of the light source with the industrial truck. In a further procedural step, the position of at least three light sources and an angle of each light source with respect to a vehicle-stationary axis are determined on the industrial truck. The position of the industrial truck is determined from the position of the identified light source and its angle. In order to allow the method to capture the spatial area completely, it is necessary to position the light sources such that at least three light sources are always visible from out each point of the spatial area. Further, the method of the present invention requires that the spatial position of the light source can be determined in the vehicle for the identified light source, for instance via a table that is stored in a memory.

In a preferred extension of the method of the present invention, the light source is unambiguously characterised in that an identification key is modulated onto the emitted radiation of the light source. The modulation of the radiation may then serve for the identification of the light source so that its position can be determined.

In a preferred extension of the method of the present invention, the radiation of the light source is detected on a height-adjustable component of the industrial truck and the position of the industrial truck and the height of the component are determined from the radiation of four light sources.

### BRIEF DESCRIPTION OF EACH OF THE FIGURES OF THE DRAWINGS

A preferred embodiment will be explained in more detail by way of the figures in the following.

FIG. 1 shows a schematic diagram in which an industrial truck determines its position with respect to four light sources.

FIG. 2 shows a schematic view of the receiving unit with a plurality of photodiodes,

FIG. 3 shows a schematic diagram with a photodiode that can be traversed in an angular range, and

FIG. 4 shows a schematic diagram with a photodiode that can be traversed in a full circle.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

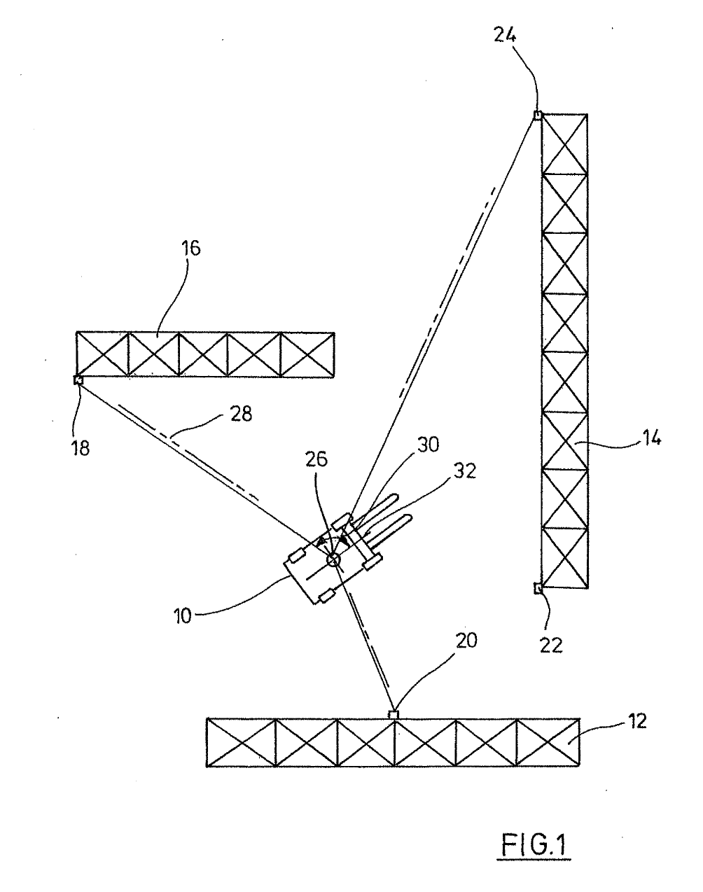

FIG. 1 shows a schematic diagram of an industrial truck 10 which occupies a position between three shelves 12, 14 and 16. Light sources 18, 20, 22 and 24 are disposed on the shelves. The light sources may be for instance light emitting diodes (LED's) that permanently emit light signals. For the light source 20 for instance, it is sufficient if the same irradiates into a spatial region of 180° that points away from the shelf 12. As light sources 18, 22 and 24 disposed on the corners of a shelf, light sources irradiating under an angle of 270° may be provided. The distribution of the light sources in the room should be performed such that at least three light sources can be received distinctly in the industrial truck at every position in the room. In case that plural industrial trucks are travelling in an area, the situation may occur that a first industrial truck prevents the free sight towards a light source. It proves therefore to be practical to provide further light sources in the room, so that cover-up of one of the light sources cannot prevent an industrial truck to receive signals from at least three light sources.

The industrial truck 10 has a receiver 26, which receives the emitted radiation of the sources 18, 20, 22 and 24. Each signal of a light source is unambiguously characterised by its modulation of an identification key. For instance, the light source 18 has the shown modulation 28, according to which a light signal is emitted as long, two times short, one time long and one time short. This sequence of long and short signals is repeated. The further light sources 20, 22 and 24 have the modulation that is also drawn in and which unambiguously characterises the light sources.

By way of example, the receiving unit 26 receives the modulation 28 under an angle 30 with respect to the vehicle's longitudinal axis 32. Through the modulation 28, it can then be analysed in the industrial truck that it is dealt with the light source 18, which is attached on the shelf 16 in a fixed spatial position. In that the position of the light sources 22 and 24 or that of arbitrary other light sources is determined, the industrial truck 10 can unambiguously determine its position. Because a runtime measurement is omitted in the position determination, it is necessary to measure at least three light sources in order to establish the position of the industrial truck unambiguously. For the rest, even the orientation of the industrial truck can be determined unambiguously, because the alignment of the vehicle's longitudinal axis 32 with respect to the three light sources is known. Thus, it may for instance be detected into which direction the industrial truck is just pointing with its load portion.

In order to avoid disturbing influences, like irradiation by the sun e.g., lighting of the shelves and the like, special frequency regions can be used, like infrared light e.g. The utilisation of particular filters, for instance of polarisation filters, is also possible. Moreover, the shown modulation of the light signals into long and short pulses provides that external effects can be excluded as far as possible. In order to determine the vehicle's position with respect to the received light signals of the light sources, it is not only necessary to identify the light source by its identification key, but in addition also to known from which direction of a light signal with respect to the vehicle the radiation had been received. When identification key and direction are known, the position of the vehicle in the plane can be determined by way of a double angle arrow method from three light signals that were received independently from each other. In case that the receiving unit is attached on a lifting frame e.g., at least four independent light signals must be received in order to determine the height of the lifting frame in addition.

In the shown realisation example according to FIG. 1, it is provided that the light sources are attached as separate light sources on the shelves 12, 14 and 16. With a corresponding modulation, it is also possible to use already existing light sources that serve for the lighting of the warehouse as a light source. For instance, an additional identification key may be modulated upon fluorescent tubes, which does not compromise the illumination of the hall but serves for the industrial truck to determine its position anyhow.

In order to determine the position, the received light signals and angle values must be processed with the aid of a computer unit. This may be done either directly on the industrial truck by way of a computer which exists there, or at a central location on a server. In the latter case there is then a radio link, for instance via W-LAN, between the industrial truck and the central server.

FIGS. 2 to 4 show different embodiments of the receiving unit 26 on the industrial truck. FIG. 2 shows a receiving unit 34, which consists of a plurality of annularly arranged photodiodes 36. For the sake of better oversight, only those photodiodes 36 are drawn in FIG. 2 which lay between nine o'clock and twelve o'clock. Each one of the photodiodes 36 captures light from out a defined angular region 38, which covers 7.5° in the shown realisation example.

By way of the information which photodiode 36 has received a signal and forwarded it for demodulation, it may be analysed in which direction the corresponding light source is located.

The obtainable angular accuracy of the apparatus 34 depends on the number of the used photodiodes and on the magnitude of the respective angular region that is covered by one photodiode. A particular advantage of the embodiment according to FIG. 2 is that the receiver has a high mechanical robustness and can be cost savingly produced without movable parts.

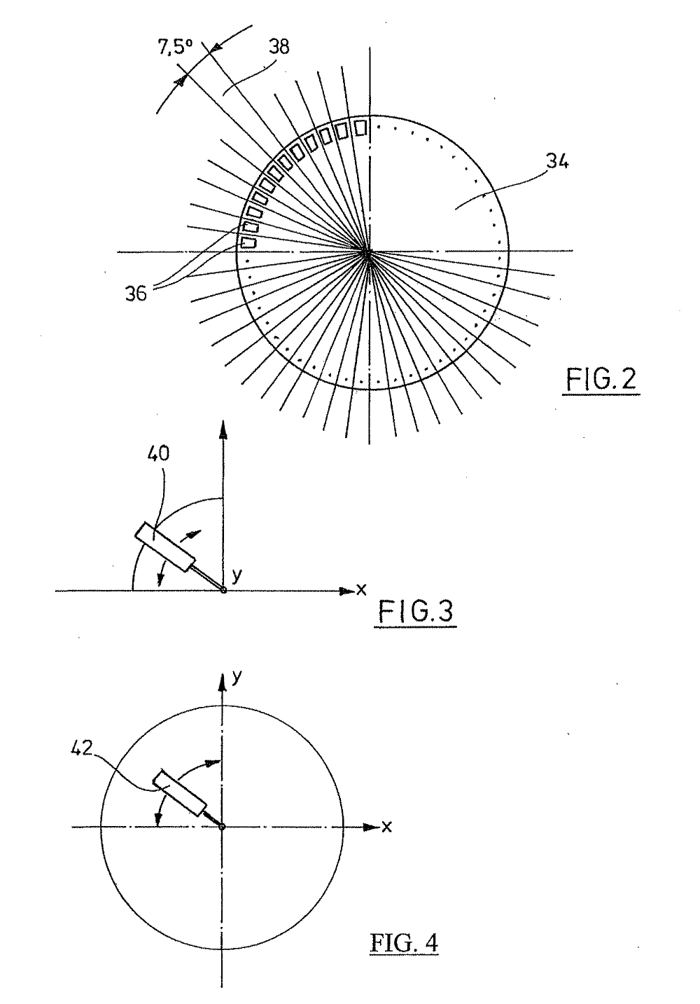

An alternative embodiment of the receiving unit is shown in FIG. 3. In this embodiment, one single photodiode or a group of photodiodes 40 is provided, which can receive light from a narrow angular region. By a controlled method of sensor alignment, light signals of different spatial directions can be received and the associated angles of incidence with respect to the orientation of the vehicle can be determined. In this method, either the sensor itself may be moved by way of suitable electromotive drives, or the light signals reach the sensor that is stationary with respect to the vehicle via a movable optics or arrangement (not shown). In this embodiment, it is advantageous that the receiving unit can be kept small, due to the utilisation of only one photodiode 40 or of a group of photodiodes. A good spatial resolution can be obtained depending on the resolution of the photodiode and the motion speed of the drives.

FIG. 4 shows a further embodiment, in which also one single photodiode 42 or a group of photodiodes is provided which can receive light from a narrow angular region. In difference to the realisation example of FIG. 3, the sensor 42 is continuously moved in a full circle here, in order to scan the complete spatial region with one single photodiode.

In a further possible embodiment, which is not shown in a figure, there is the possibility to provide a tetrahedron or a prism consisting of a transparent material in order to capture the light signal and the angle of the light source. When the light hits the tetrahedron or the prism, there will be a differing intensity distribution on the surface thereof, which can be recognised with photodiodes that are disposed in a correspondingly distributed fashion. From the known alignment of the deflecting body with respect to the vehicle and the differently detected light intensities on the surface of the body, conclusion can be made regarding the position of the received light source. The modulated identification key of the light signals is not disturbed by using a deflecting body made of a transparent material. The particular advantage of this approach is that the mechanical construction is simple and no sensor has to be moved spatially.

In a further embodiment, which is not shown in the figures, a CCD camera is used as the receiving unit on the vehicle, which can identify light sources provided with an identification key in its field of vision. For this it is necessary that the camera works with a scanning speed that is as high as possible and which has at least twice the modulation frequency of the light signals that are to be detected. With this sensor, the determination of the position is performed in that the light signals received by the vehicle and the relative positions thereof with respect to each other are compared with the known and memorised position data of the light sources.

The installation of the receiving unit is made on a site of the industrial truck at which a panoramic view as free as possible towards all sides is given, so that as much light sources as possible can be recognised at the same time. It is also conceivable to attach the sensor in the region of the vertically movable lifting frame of the industrial truck, wherein a fourth light source has then to be analysed in addition in order to recognise a lifting height.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. An apparatus for determining the position of an industrial truck (10) within a spatial area, in which plural light sources (18, 20, 22, 24) are positioned at predefined locations and emit a radiation (28) that unambiguously characterises the light source without interaction with the industrial truck, wherein the industrial truck has a receiving unit (26) for the radiation of the light sources, which is adapted to identify the light source from the received radiation and to determine an angle (30) of the light source with respect to a vehicle-stationary axis (32), and the industrial truck further has an analysing unit which is adapted to determine the position of the industrial truck from at least three identified light sources and the angles thereof.

2. An apparatus for determining the position according to claim 1, characterised in that each of the light sources emits the radiation (28) permanently or according to a predetermined time plan.

3. An apparatus according to claim 1, characterised in that each light source emits an unambiguous identification key (28) which is modulated onto the emitted radiation.

4. An apparatus according to claim 3, characterised in that the identification key is modulated by a radiation having two different intensities.

5. An apparatus according to claim 1, characterised in that the light sources emit radiation each with a predetermined frequency and/or in a predetermined frequency interval.

6. An apparatus according to claim 1, characterised in that the receiving unit is disposed on a height-adjustable component of the industrial truck and the analysing unit is adapted to determine the position of the industrial truck and the height of the component from at least four identified light sources and their angles.

7. An apparatus according to claim 1, characterised in that the receiving unit has a plurality of circularly disposed photodiodes (36) which can receive radiation in a predetermined angle interval.

8. An apparatus according to claim 1, characterised in that the receiving unit has one or plural photodiodes (40) on a rotatable holder, wherein the photodiodes can receive radiation in a predetermined angle interval and the holder can be traversed into defined angular positions with respect to the vehicle-stationary axis.

9. An apparatus according to claim 1, characterised in that the receiving unit has at least one deflecting body, which deflects an incident radiation depending on the angle of incidence of the radiation and directs it to at least one photodiode.

10. An apparatus according to claim 1, characterised in that the receiving unit has at least one two-dimensional photo sensor, wherein the analysing unit and/or the photo sensor determine(s) the angle of the light source with respect to the vehicle-stationary axis from the position of the incident radiation on the two-dimensional photo sensor.

11. A method for determining the position of an industrial truck within a spatial area, in which plural light sources emit a radiation characterising the light source from out predefined positions, wherein the emission of the radiation occurs without interaction with the industrial truck and the position of at least three light sources and an angle of each light source with respect to a vehicle-stationary axis is determined on the industrial truck in the method, in order to determine the position of the industrial truck from the position of the identified light sources and their angle with respect to the vehicle axis.

12. A method according to claim 11, characterised in that each of the light sources emits the radiation (28) that characterises the light source permanently or according to a predetermined time plan.

13. A method according to claim 11, characterised in that an identification key that characterises the light source unambiguously is modulated onto the emitted radiation of the light source.

14. A method according to claim 1, characterised in that the radiation of the light source is detected on a height-adjustable component of the industrial truck and the position of the industrial truck and the height of the component is determined from the radiation of four light sources.
